(19) United States
(12) Patent Application Publication
(10) Pub. No.: US 2008/0231861 A1
(43) Pub. Date: Sep. 25, 2008

(54) Polarization Maintaining Optical Delay Circuit

(75) Inventor: Bernd Nebendahl, Ditzingen (DE)

Correspondence Address: AGILENT TECHNOLOGIES INC., INTELLECTUAL PROPERTY ADMINISTRATION,LEGAL DEPT., MS BLDG. E P.O. BOX 7599, LOVELAND, CO, 80537, US

(73) Assignee: AGILENT TECHNOLOGIES, INC., Palo Alto, CA (US)

(21) Appl. No.: 12/064,347

(22) PCT Filed: Aug. 24, 2005
(86) PCT No.: PCT/EP05/54169

§ 371 Date: Feb. 21, 2008

(51) Int. Cl. G01B 9/02; G02F 1/00

(52) U.S. Cl. 356/491; 359/263

(57) ABSTRACT

The invention relates to a polarization maintaining optical delay circuit (1) for providing a time delay to an incident light (S1), comprising an optical directional element (11) adapted for directing an incident light (S1) from a first port (111) to a second port (112) and directing a returning light from the second port to a third port (113), a mirror element (12) adapted for reflecting the incident light (S1), thereby changing the polarization state, so that the returning light (S2) has a substantially orthogonal polarization state compared to the polarization state of the incident light (S1), and an optical waveguide (13) adapted for optically connecting the second port (112) of the optical directional element (11) and the mirror element (12). The invention also relates to a ring cavity (2,3) comprising such an optical delay circuit, and an optical interferometer (4,5) with said optical delay circuit.

### BACKGROUND ART

The present invention relates to modifying an optical signal by optical delay circuits.

Optical delay circuits, e.g. comprising an optical fiber of a defined length, generate specific time delays to optical signals. Delay lines are widely applied in optical applications. An example for such an application is given by the International Application PCT/EP 0207726 of the same applicant, describing the introduction of a delay line in a reference arm of an interferometer.

### DISCLOSURE

It is an object of the invention to provide an improved optical delay circuit. The object is solved by the independent claims. Further embodiments are shown by the dependent claims.

According to embodiments of the present invention, an optical delay circuit for providing a time delay to an incident light, comprises an optical directional element adapted for directing an incident light from a first port to second port and directing a returning light from the second port to a third port, a mirror element adapted for reflecting the incident light, thereby rotating the state of polarization, further also referred to as Faraday Mirror, so that the returning light has a substantially orthogonal polarization state compared to the polarization state of the incident light and an optical waveguide adapted for optically connecting the second port of the optical directional element and the mirror element.

Each optical signal can be regarded as being composed of a first signal fraction with a polarization parallel to the first main polarization axis and a second fraction with a polarization parallel to the second main polarization axis of the waveguide. In a non-polarization maintaining waveguide the main axes can change due to mechanical or thermal stress. Because of that it is not possible to couple to light to only one axis. Additionally both fractions need different travel times for traveling along the waveguide. By rotating the state of polarization by 90° at the Faraday mirror, travel time differences of both fractions add up to zero by traveling forth and back the waveguide

In an embodiment, the optical waveguide have dispersion compensating characteristics. Therefore, the optical waveguide might comprise a single mode fiber section connected in series to a dispersion compensating fiber section.

In an embodiment, the optical directional element comprises a polarization dependent beam splitter that is adapted to select the light fraction of a first main polarization axis of the incident light to be coupled from the first port to the third port, and the light fraction of the other main polarization axis of the returning light to be coupled from the second port to the third port. Alternatively, the optical directional element might be realized as optical circulator

In a further embodiment, the optical delay circuit is applied in a ring cavity comprising an optical path for a circulating optical light and a gain medium located in the optical path. Therefore, the optical delay circuit is connected in the optical path through the first port and the third port.

The ring cavity has preferably polarization maintaining characteristics. Therefore, the optical path might be realized by a polarization maintaining optical fiber. Alternatively, a single mode fiber is used in addition to polarization compensating elements connected into the optical path.

Alternatively to the fiber ring, the optical path might be realized as a free space circuit comprising a plurality of edge mirrors. The gain medium is preferably realized as semiconductor optical amplifier and the optical directional element is realized as polarization dependent beam splitter. For compensating the polarization rotation by the optical delay circuit, the optical ring cavity further comprises a half wave plate, by way of example connected between the optical directional element and the gain medium.

In a further embodiment, the optical delay circuit is inserted into one of two paths of an optical interferometer. The optical interferometer might be realized as transmissive circuit (Mach Zehnder Interferometer) or as reflective circuit (Michelson Interferometer).

### BRIEF DESCRIPTION OF DRAWINGS

Other objects and many of the attendant advantages of embodiments of the present invention will be readily appreciated and become better understood by reference to the following more detailed description of embodiments in connection with the accompanied drawings. Features that are substantially or functionally equal or similar will be referred to by the same reference signs.

FIG. 1 shows a block diagram of an optical delay line according to the invention,

FIG. 2 shows an exemplary block diagram of a fiber ring cavity comprising the optical delay line of FIG. 1,

FIG. 3 shows an exemplary block diagram of a free space ring cavity comprising the optical delay line of FIG. 1,

FIG. 4 shows an exemplary block diagram of a transmissive interferometer comprising the optical delay line of FIG. 1, and

FIG. 5 shows an exemplary block diagram of a reflective interferometer comprising the optical delay line of FIG. 1.

FIG. 1 shows an exemplary block diagram of an optical delay circuit 1 comprising a an optical directional element 11, a polarization-rotating mirror element 12 and an optical waveguide 13 optically connecting the optical directional element 11 and the polarization-rotating mirror 12 together. The optical directional element 11 comprises a first port 111 representing an input port of the optical delay circuit 1, a second port 112 to be connected to a first end of the optical waveguide 13, and a third port 113 representing an output port of the optical delay circuit 1. Incident light S1 received at the first port 111 is directed to the second port 112, where it is emitted into the optical waveguide 13. The second end of this waveguide is connected to the polarization-rotating mirror 12, that substantially reflects the incident light S1, traveling back as returned light S2 to the second port 112 of the optical directional element 11. The optical directional element 11 directs the returned light S2 from the second port 112 to the third port 113.

In many optical applications, it is important to provide a substantially dispersion-free optical path. Therefore, in an embodiment, the optical waveguide comprises a first section of a single mode fiber SMF and a second section of a dispersion compensating fiber DCF. Typically a DCF has a negative dispersion, with nominal values that are typically significantly higher than those of the fiber to compensate for. Thus, the length of the DCF section and the SMF are selected such that the waveguide 13 does not show a resulting dispersion. In an alternative, the resulting dispersion might be chosen to compensate a dispersion of an optical circuit connected to delay line 1.

The SMF section and, the DCF sections shows birefringent properties and thus are not polarization maintaining, i.e. the SOP of the incident beam at the first end of the waveguide is likely to be different compared to the SOP at the second end of the optical waveguide. Moreover, the polarization change over the optical waveguide is not predictable and might vary over the time e.g. due to aging or environmental variations. However, it is often a second condition additionally to the dispersion compensating condition described above that the delay line should be substantially polarization maintaining.

The incident light can generally be regarded as being composed of a first fraction of a first main polarization axis and a second fraction of a second main polarization axis, both axes being orthogonal to each other. Due to the birefringent property of the SMF and DCF, both fractions will need different time periods for traveling along the waveguide 13 from the input of the time delay circuit to the mirror 12. This time difference however can be compensated for, if both fractions of light change their polarization axes for traveling back to the output, so that the sums of the travel times forwards an backwards are equal. This is achieved rotating the polarization of the incident beam by 90° at the polarization-rotating mirror 12.

The polarization-rotating mirror 12, further also referred to as Faraday mirror, makes use of the so-called Faraday Effect describing a non-reciprocal rotation of a signal's polarization as it passes through an optical medium within a magnetic field. Situated at the end of the optical waveguide 13, the Faraday Mirror rotates the incident light's state of polarization (SOP) by 45° twice; once when the light enters, and again when the light is reflected back into the waveguide. Since the Faraday effect is non-reciprocal, the SOP of the returning light S2 is rotated by 90° with respect to the incident light S1, thus having an orthogonal polarization state compared to the polarization state of the incident light S1.

In a further embodiment, the time delay imposed by the waveguide 13 is selectable. Therefore, a set of further fiber sections of different lengths might be provided whereof one or more can be switched in series to the other fiber sections of the waveguide 13. Alternatively, the path length of the waveguide might be varied by changing optical properties of some elements. Therefore, optical devices, e.g. of LCD or LiNb03, can be used that change the refractive index depending on the applied electrical field.

The optical delay circuit 1 can be used in a variety of different optical applications. In the following, some of these applications are described without limiting the invention to only the described applications.

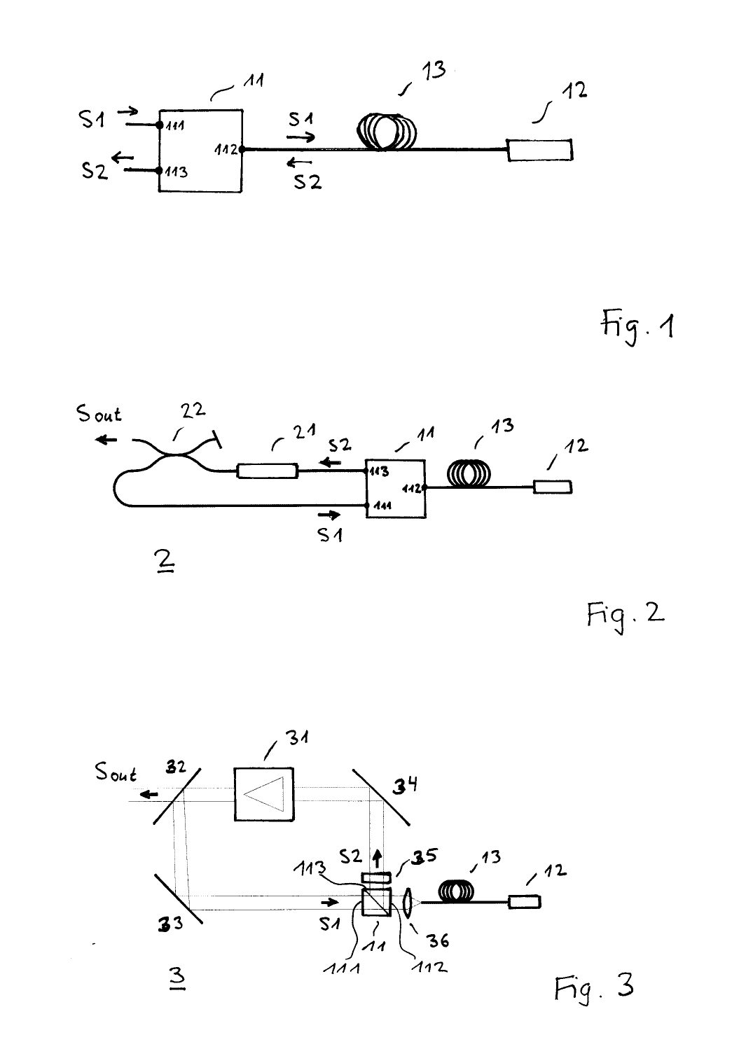

FIG. 2 shows an exemplary block diagram of a fiber ring cavity adapted for guiding an optical beam traveling on an optical path representing a closed loop. The ring cavity comprises a gain medium 21, an optical splitter 22, and the delay circuit 1 of FIG. 1 comprising the optical directional element 11, the polarization-rotating mirror element 12 and the optical waveguide 13. The gain medium 21, the optical splitter 22 and the optical directional element 11 are circularly connected by a polarization maintaining optical fiber, further also referred to as ring fiber.

The gain medium 21 coupled into the optical path amplifies the circulating light by stimulated emission. The gain medium 21 might be realized as semiconductor optical amplifier (SOA). In this case, collimating devices not shown in FIG. 2 might be provided to couple the light from the ring fiber into the active layer of the SOA and vice versa.

In an alternative, the gain medium 21 might be realized as an erbium-doped fiber amplifier EDFA. The erbium-doped fiber (EDF) is backward-pumped through a coupler by a high-power laser diode e.g. emitting at a wavelength of 980 nm.

The laser light by way of example travels anti-clockwise starting from the gain medium 21 over the optical splitter 22, where a fraction of the circulating light is coupled out of the cavity, to the input of the optical delay circuit 1 forming the incident light S1. The returning light S2 returning from the optical delay circuit 1 travels back from the output of optical delay circuit 1 to the gain medium 21. As the SOP at the output of the optical delay circuit 1 is rotated by 90°, the ring fiber has to be twisted by 90°, when connecting to the output port. As the ring fiber is polarization marinating and the optical delay circuit exactly rotates the SOP of the returned light by 90° compared to the incident light, the whole cavity 2 is polarization maintaining. Further, as the dispersion of the cavity is compensated by the DCF of the waveguide 13, the whole cavity 2 is dispersion free. As for such arrangement, the resonance condition in the ring resonator is that the optical path length for one roundtrip along the closed loop is an integer multiple of the resonance wavelength, the frequency distance between the resonating frequencies is constant and independent from the wavelength.

In general, the light might circulate in any or both path directions. However, e.g. for maximizing the power of the out coupled light Sₒᵤₜ, it is desired that the light circulates only in one direction. Therefore an optical isolator might be provided somewhere in the optical path.

In an embodiment, the ring cavity 2 might further comprise a mode-selecting filter (not shown) for filtering out one or more longitudinal laser modes from the comb of resonating modes. The spectral response then corresponds to a multiplication of the spectrum of the cavity and the spectrum of the mode-selecting filter. Those modes are consequently selected that fall within the pass bands of the resulting spectrum. In order to achieve a matching of the mode-selecting filter characteristics and the cavity characteristics, both characteristics might be adjusted to each other, e.g. by design, by open loop control or by closed loop control, so that the laser light resonates at the selected modes. Further information about external cavities with multiple stabilized modes can be drawn from European Application No. 04103969.4 of the same applicant.

The cavity characteristics, e.g. the cavity path length, might be controlled by appropriately modify the optical path length of the optical delay circuit 1 as described above. The length modification is preferably coupled with the wavelength filter in order to adjust and/or to synchronize variations in the wavelength selection provided by the wavelength filter with the optical path length. Thus, e.g. mode hops occurring when tuning the optical beam in wavelength can be reduced or even be avoided.

In an alternative, after being collimated, an optical detector (not shown) detects the light coupled out by the splitter 22. The optical detector generates an electrical signal. If the detector has band pass filtering characteristics, an electrical output signal is generated of only down-mixed frequencies, i.e. signal portions at differences of frequencies of different laser modes. This allows for generating stabilized high frequency electrical signals.

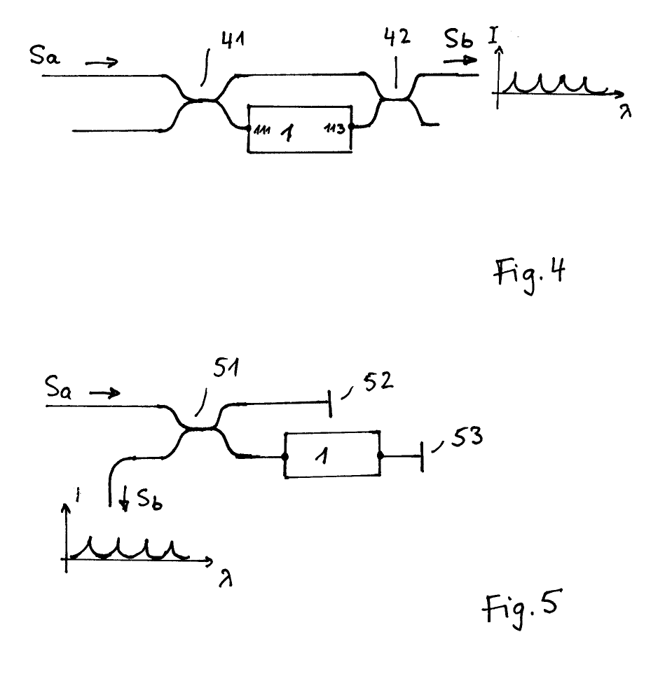

As an alternative to the fiber ring solution described above, FIG. 3 shows exemplary block diagram of a free space ring cavity. Similar to FIG. 2, a circulating light is guided along an optical path representing a closed loop. The ring cavity comprises a gain medium 21, a plurality of edge mirrors 32, 33, 34, and the optical delay circuit 1 of FIG. 1. The gain medium (31) is realized as semiconductor optical amplifier. By way of example three edge mirrors 32, 33 and 34 are shown each reflecting the received light by 90°. For coupling out an output signal Sₒᵤₜ, one of the edge mirrors might be realized as partly reflective mirror. Alternatively, the light might be coupled out by a simple beam splitter.

The optical directional element 11 comprises a polarization dependent beam splitter by way of example situated at one edge of the ring, wherein the incident beam S1 incident on the first port (or surface) 111 leaves the beam splitter at the second port (or surface) 112 in unchanged direction before hitting a collimating lens 36. The collimating lens focuses the incident beam S1 onto the waveguide 13. The returning light S2 emitting from the waveguide 13 is collimated by the same collimating lens 36 before hitting the polarization dependent beam splitter from the other direction. As the SOP of the returning light is rotated by 90°, the polarization dependent beam splitter 11 reflects the returning light, so that the reflected returning light beam emitting at the third port (or surface) 113 and the incident light beam form an angle 90°. The 90°-rotation of the SOP is turned back by a half wave plate 35 situated by way of example between the output port of the polarization dependent beam splitter and the next edge mirror 34.

As described above, an optical isolator might be provided somewhere in the optical path, so that the light circulates only in one direction.

The polarization dependent beam splitter 11 might be realized as an optical dielectric layer that is usually located between two glass parts. Alternatively, the polarization dependent beam splitter might be realized using birefringent solid-state crystal.

In the following, two examples are shown for using an optical delay line according to the invention in optical interferometers. FIG. 4 shows a first example with a transmissive optical interferometer or Mach-Zehnder interferometer comprising an optical splitter 41 for splitting the interferometer input optical signal Sₐ into two interferometer paths and an optical combiner 42 for combining the split signals into an interferometer output optical signal S_{b}. The optical delay circuit 1 of FIG. 1 is connected into one of the interferometer paths by the first port 111 and the third port 113. As the optical delay circuit 1 is polarization maintaining, both signals received by the combiner 42 have the same SOP.

The frequency of the input optical signal Sₐ is tunable. The intensity I of the output optical signal S_{b}. depends on the wavelength λ and the time delay imposed by the delay circuit 1. If the delay circuit 1 is dispersion compensated, the intensity I of output optical signal S_{b} over the wavelength λ shows equidistant peaks, wherein the frequency distances at the peaks are equal and independent from the wavelength λ of the input optical signal Sₐ.

FIG. 5 shows a second example with a reflective optical interferometer or Michelson interferometer comprising a four port optical coupler 51 for splitting the interferometer input optical signal Sₐ received at a first port into two optical paths connected to a second and a third port of the optical coupler. The optical paths are each terminated by an optical mirror 52 and 53 reflecting the signals back to each the second and third port of the optical coupler 51. The optical coupler combines the reflected signals, and emits the corresponding interferometer output signal S_{b} at a fourth port. Similar to FIG. 4, the optical delay circuit of FIG. 1 is connected into one of the interferometer paths by the first port 111 and the third port 113.

1-13. (canceled)

14. An optical delay circuit for providing a polarization maintaining delay to an incident light, comprising:
an optical directional element adapted for directing an incident light from a first port to second port and directing a returning light from the second port to a third port,
a mirror element adapted for reflecting the incident light, thereby changing the polarization state, so that the returning light has a substantially orthogonal polarization state compared to the polarization state of the incident light, and
an optical waveguide adapted for optically connecting the second port of the optical directional element and the mirror element, the optical waveguide comprising a dispersion compensating device.

15. The delay circuit of claim 14 wherein the optical waveguide is designed to one of: being dispersion free, and compensating a dispersion of an optical circuit being connected to the delay line.

16. The delay circuit of claim 14, wherein the optical waveguide comprises a section being a dispersion compensating fiber.

17. The delay circuit of claim 16, wherein the optical waveguide comprises a single mode fiber section connected in series to the dispersion compensating fiber section.

18. The delay circuit of claim 14, wherein the optical directional element comprises a polarization dependent beam splitter that is adapted to select the light fraction of a first main polarization axis of the incident light to be coupled from the first port to the second port, and the light fraction of the other main polarization axis of the returning light to be coupled from the second port to the third port.

19. A ring cavity comprising:
means for constituting an optical path for a circulating optical light,
a gain medium located within the optical path, and
the optical delay circuit of claim 14, wherein the optical delay circuit is connected in the optical path through the first port and the third port.

20. The ring cavity of claim 19, further comprising an optical coupler connected into the optical path for coupling out a fraction of the circulating light as output light.

21. The ring cavity of claim 20, further comprising an opto-electrical converter adapted for receiving the output light and generating an electrical signal oscillating at frequencies corresponding to differences of frequencies of different modes of the circulating light.

22. The ring cavity of claim 19, further comprising an optical isolator connected into the optical path so that the circulating light circulates in one defined direction.

23. The ring cavity of claim 19, wherein the optical path is realized by a polarization maintaining optical fiber.

24. The ring cavity of claim 19, wherein the optical path is a free space circuit comprising a plurality of edge mirrors, wherein the gain medium is realized as semiconductor optical amplifier and the optical directional element is realized as polarization dependent beam splitter, and further comprising a half wave plate inserted into the optical path for adapting the polarization state of the returning beam to the polarization state of the incident beam.

25. An optical interferometer comprising:
an optical input for receiving an input optical signal,
splitting and combining means for splitting the input optical signal onto two optical paths and combining the signals split onto the two paths into an output optical signal,
wherein one of the optical paths comprises the optical delay circuit of claim 1.

26. The optical interferometer of claim 25, wherein both optical paths are each terminated by an optical mirror, wherein the splitting and combining means is realized as a four port optical coupler that is adapted to split the input optical signal received a first coupler port into two partial signals emitted a second and a third coupler port connected to each one of the two paths, to receive each a reflected signal reflected by the optical mirrors at the second and third coupler port, and to emit the output optical signal at a fourth coupler port.

27. A method of providing a time delay to an incident light, comprising:
directing an incident light from an input port to a first end of an optical waveguide,
generating at a second end of the optical waveguide a returning light by reflecting and changing the polarization state of the incident light, so that the returning light has a substantially orthogonal polarization state compared to the polarization state of the incident light, and
directing the returning light from the first end of the optical waveguide to an output port.
